(19) United States
(12) Patent Application Publication
(10) Pub. No.: US 2014/0319256 A1
(43) Pub. Date: Oct. 30, 2014

(54) LINER FASTENER

(71) Applicant: Lachlan David KNIGHT, Prahran, Victoria (AU)

(72) Inventor: Lachlan David Knight, Armadale (AU)

(21) Appl. No.: 14/366,497

(22) PCT Filed: Dec. 13, 2012
(86) PCT No.: PCT/AU2012/001529

§ 371 Date: Jun. 18, 2014

(30) Foreign Application Priority Data
Dec. 23, 2011 (AU) 2011905443

(51) Int. Cl. B02C 17/22; B02C 17/18

(52) U.S. Cl. CPC B02C 17/22; B02C 17/18
USPC 241/182; 29/525.02

(57) ABSTRACT

A liner fastener for fastening a liner to a rotatable shell of a grinding mill, the fastener comprising a flexible tie, retaining means for retaining the fastener relative to the liner, and a tensioning fitting, wherein the flexible tie is adapted to be inserted into a mounting aperture in the shell, and the tensioning fitting is adapted to be fitted to an end portion of the flexible tie protruding outside the shell to bear against the shell and to maintain tension in the fastener to thereby fasten the liner to the shell.

### FIELD OF THE INVENTION

The invention relates to a liner fastener for fastening a liner to a rotatable shell of a grinding mill, and more particularly, but not exclusively, to a fastening device for securing internal liners to mills typically used in the mining industry, such as autogenous (AG), semi-autogenous (SAG), ball, pebble and rod mills.

### BACKGROUND OF THE INVENTION

Mills typically used in the mining industry often employ a lining of heavy steel, rubber or composite liner segments secured to the inside of the mill using liner bolts. One such previously known arrangement is shown in FIG. 1. These liners serve two purposes, they provide the appropriate interface between the mill shell and the ore to create the grinding action within the mill, and they protect the mill shell from being damaged by the grinding process. These liners require routine replacement as they wear down during the grinding process, and this task is generally the largest cause of mill down time. Mill down time negatively affects the economic efficiency of the grinding process, so much so that an entire industry has developed in pursuit of its reduction. Routine replacement of the liners is known to significantly delay processing operations.

FIG. 1 shows a conventional liner 10 which is fastened to a mill shell 12 by way of a liner bolt 14, used in combination with a washer 16 and a nut 18. The washer 16 may comprise a recessed O-ring for sealing between the mill shell 12 and washer 16. A rubber sheet 20 is interposed between the liner 10 and the mill shell 12.

During operation of a mill, the liners and liner bolts wear and deform, and the clearances around the liner bolts become filled with compacted ore fines. As a result, the liner bolts are typically very difficult to remove when the liners require replacement, making liner bolt removal one of the most time consuming operations undertaken when replacing liners.

The applicant has identified that there is a problem in that to remove a conventional liner, the liner bolts must first be removed by driving them back through their original entry path. Typical methods to drive liner bolts back comprise manually operated sledge hammers, and more commonly reciprocating power hammers suspended from a crane (such as the RME Thunderbolt hammer) or mounted to a mobile vehicle (such as a modified skid-steer loader).

Regardless of the method chosen, the process of removing liner bolts is a time-consuming task, and may result in injury to workers and/or damage to the mill shell as a result of the aggressive tools used.

Examples of the invention seek to replace conventional liner bolts with an improved liner fastener which does not need to be driven back through its original entry path when replacing liners, thereby overcoming or at least alleviating the above-mentioned disadvantages.

### SUMMARY OF THE INVENTION

In accordance with one aspect of the present invention, there is provided a liner fastener for fastening a liner to a rotatable shell of a grinding mill, the fastener comprising a flexible tie, a retainer fitting for retaining the fastener relative to an aperture of the liner, and a tensioning fitting, wherein the flexible tie is adapted to be inserted into the liner aperture and a corresponding mounting aperture in the shell and fed through such that the retainer fitting becomes anchored within a socket formed in the aperture of the liner, and the tensioning fitting is adapted to be fitted to an end portion of the flexible tie protruding outside the shell to bear against the shell and to maintain tension in the fastener to thereby fasten the liner to the shell.

Preferably, the flexible tie is adapted to be inserted from an inside of the liner. Alternatively, the flexible tie may be inserted from outside the liner.

Preferably, the flexible tie is in the form of a length of wire rope.

Preferably, the retainer fitting is in the form of a wedge collar and barrel assembly. Alternatively, the flexible tie may be anchored to the retainer fitting by way of a swaging process.

In a preferred form, the retainer fitting is dimensioned so as to prevent the retainer fitting from passing through the liner aperture.

In a preferred form, the retainer fitting is dimensioned so as to prevent lateral movement of the liner relative to the mill shell.

Preferably, the tensioning fitting is in the form of a wedge collar and barrel assembly, the wedge collar being arranged within a tapered interior of the barrel to permit one-way movement of said assembly along the flexible tie.

In accordance with another aspect of the present invention, there is provided a liner fastener when used to fasten a liner to a rotatable shell of a grinding mill, the fastener comprising a flexible tie, a retainer fitting, and a tensioning fitting, wherein the flexible tie is inserted into a liner aperture and a corresponding mounting aperture in the shell, the retainer fitting is anchored within a socket formed in the liner aperture to anchor the fastener against further displacement through the liner aperture, and the tensioning fitting is fitted to an end portion of the flexible tie protruding outside the shell, the tensioning fitting bearing against the shell to maintain tension in the flexible tie thereby fastening the liner to the shell.

Preferably, the flexible tie is inserted through the liner aperture from an inside of the liner.

In accordance with another aspect of the present invention, there is provided a method of fastening a liner to a rotatable shell of a grinding mill, the fastener comprising a flexible tie, a retainer fitting for retaining the fastener relative to an aperture of the liner, and a tensioning fitting, the method including the steps of:
inserting the flexible tie into the liner aperture and a corresponding mounting aperture in the shell;
feeding the flexible tie through the liner aperture such that the retainer fitting becomes anchored within a socket formed in the aperture of the liner; and
fitting the tensioning fitting to an end portion of the flexible tie protruding outside the shell with the tensioning fitting bearing against the shell to maintain tension in the fastener to thereby fasten the liner to the shell.

In accordance with yet another aspect of the present invention, there is provided a liner fastener for fastening a liner to a rotatable shell of a grinding mill, the fastener comprising a flexible tie, retaining means for retaining the fastener relative to the liner, and a tensioning fitting, wherein the flexible tie is adapted to be inserted through a mounting aperture in the shell, and the tensioning fitting is adapted to be fitted to an end portion of the flexible tie protruding outside the shell to bear against the shell and to maintain tension. in the fastener to thereby fasten the liner to the shell.

Preferably, the retaining means is in the form of one end portion of the flexible fie being embedded in the liner.

Preferably, the retaining means is in the form of one end portion of the flexible tie being integrally formed as part of the liner.

Preferably, the retaining means is in the form of a retainer fitting attached to one end portion of the flexible tie.

Preferably, the retaining means is in the form of a retainer fitting integrated within the liner, adapted such that the flexible tie may be inserted from an outside of the rotatable shell, through a mounting aperture in the shell, and into the retainer fitting, such that the retainer fitting becomes attached to one end portion of the flexible tie.

More preferably, the retainer fitting is in the form of a wedge collar and barrel assembly.

Preferably, the retaining means is dimensioned so as to prevent lateral movement of the liner relative to the mill shell.

In accordance with yet another aspect of the present invention, there is provided a liner fastener when used to fasten a liner to a rotatable shell of a grinding mill, the fastener comprising a flexible tie, retaining means for retaining the fastener relative to the liner, and a tensioning fitting, wherein the flexible tie is inserted through a mounting aperture in the shell, and the tensioning fitting is fitted to an end portion of the flexible tie protruding outside the shell, the tensioning fitting bearing against the shell to maintain tension in the flexible tie thereby fastening the liner to the shell.

In accordance with yet another aspect of the present invention, there is provided a method of fastening a liner to a rotatable shell of a grinding mill, the fastener comprising a flexible tie, retaining means for retaining the fastener relative to the liner, and a tensioning fitting, the method including the steps of:
inserting the flexible tie through a mounting aperture in the shell; and
fitting the tensioning fitting to an end portion of the flexible tie protruding outside the shell with the tensioning fitting bearing against the shell to maintain tension in the fastener to thereby fasten the liner to the shell.

### BRIEF DESCRIPTION OF THE DRAWINGS

The invention is described, by way of non-limiting example only, with reference to the accompanying drawings, in which:

FIG. 1 shows a conventional liner and liner bolt arrangement;

FIG. 2 shows a liner fastener in accordance with an example of the present invention;

FIG. 3 shows a liner secured to a mill shell using a liner fastener in accordance with an example of the present invention;

FIG. 4 shows a cross-sectional view of an arrangement similar to the one shown in FIG. 3;

FIG. 5 shows a liner secured to a mill shell using a liner fastener in accordance with an alternative example of the present invention;

FIG. 6 shows a liner secured to a mill shell using a liner fastener in accordance with another alternative example of the present invention;

FIG. 7 shows a trial liner fastener product;
FIG. 8 shows components of the liner fastener product of FIG. 7;

FIG. 9 shows the liner fastener product of FIG. 7 being installed; and

FIG. 10 shows an outer end of the fastener product of FIG. 7, once installed.

### DETAILED DESCRIPTION

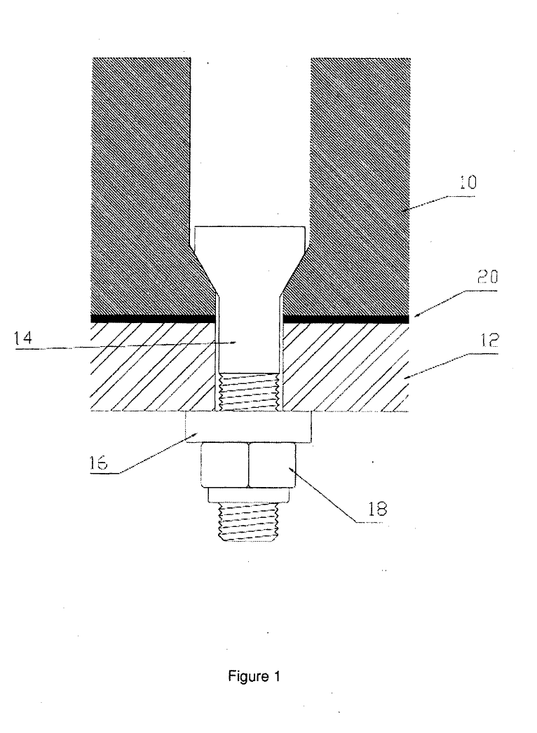

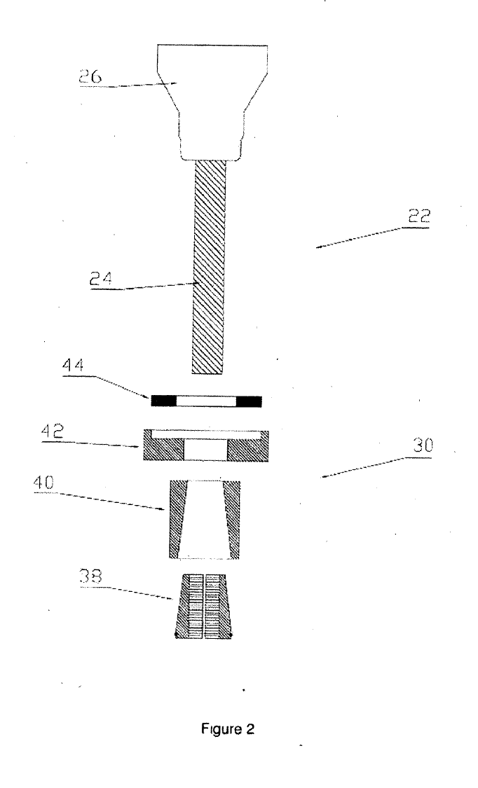

With reference to FIGS. 2 to 10 of the drawings, there is shown a liner fastener 22 for fastening a liner 10 to a rotatable shell 12 of a grinding mill, the fastener 22 including a flexible tie 24. The inclusion of a flexible tie 24 gives the liner fastener 22 multiple advantages in use when compared to the conventional liner bolt 14 shown in FIG. 1, including removing the need to drive the liner fastener 22 back through its original entry path when replacing liners 10, and it is this flexible tie 24 that is at the foundation of the present invention.

Advantageously, the flexible tie 24 enables replacement of the liner 10 without needing to drive the liner fastener 22 back through its original entry path. As the tie 24 is flexible, it is able to bend and move around so as to facilitate removal of the liner 10 from the mill shell 12 without removing the liner fastener 22 from the liner 10. Furthermore, as the tie 24 is flexible, it prevents jamming of the liner fastener 22 in the mounting aperture 32 of the mill shell 12 during removal of the liner 10 from the mill shell 12. Advantageously, the flexible tie 24 may be of relatively smaller cross-sectional dimension than existing liner bolts 14 such that the liner fastener 22 is able to be withdrawn more easily from the mounting apertures 32 in the mill shell 12 during removal of the liner 10 from the mill shell 12.

It is of benefit that the flexible tie 24 may have relatively greater elastic elongation under tension than conventional liner bolts 14. During the grinding process, movement of the liners 10 relative to the shell 12 typically results in tension in conventional liner bolts 14 being reduced, due to their small elastic elongation under tension. This typically leads to mill down time whilst liner bolts 14 are re-tensioned. Advantageously, the arrangement of the present invention may retain tension more effectively, such that re-tensioning of the liner fasteners 22 after a period of mill operation is not required.

Advantageously, the flexible tie 24 may resist fatigue failure caused by vibration and movement of the liner 10 relative to the shell 12 to a greater extent than a conventional liner bolt 14. Fatigue failure of a liner bolt 14 typically leads to mill down time for bolt 14 replacement, while the risk of a dislodged nut 18, washer 16 and shank section of a fractured liner bolt 14 being thrown from the mill during operation and hitting personnel in the area is an ongoing hazard associated with conventional liner bolts 14.

Advantageously, the flexible tie 24, may be used as an anchor point for the liner 10, after the worn liner 10 has been knocked into the mill and requires removal for disposal.

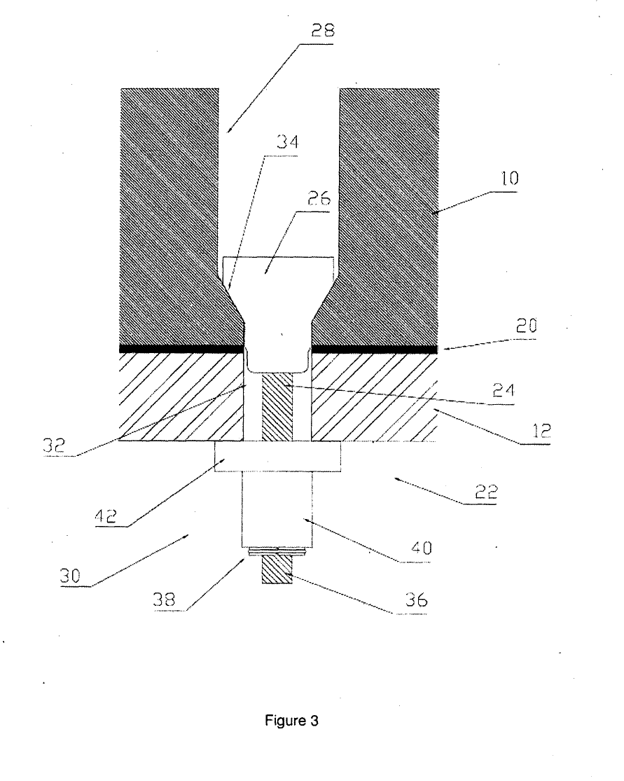

More specifically, with reference to FIGS. 2 to 4 of the drawings, there is shown a first example of a liner fastener 22 which includes a retainer fitting 26. In particular, there is provided a liner fastener 22 for fastening a liner 10 to a rotatable shell 12 of a grinding mill. The fastener 22 comprises a flexible tie 24, a retainer fitting 26 for retaining the fastener 22 relative to an aperture 28 of the liner 10, and a tensioning fitting 30. The flexible tie 24 is adapted to be inserted into the liner aperture 28 and a corresponding mounting aperture 32 in the shell 12, and to be fed through such that the retainer fitting 26 becomes anchored within a socket 34 formed in the aperture 28 of the liner 10. In the example shown in FIG. 3, the fastener 22 is inserted into the liner aperture 28 from an inside of the liner 10, however it will be understood that in alternative examples, the fastener 22 may instead inserted from outside the liner 10 (and outside the shell 12). The tensioning fitting 30 is adapted to be fitted to an end portion 36 of the flexible tie 24 protruding outside the shell 12 to bear against the shell 12 and to maintain tension in the fastener 22 to thereby fasten the liner 10 to the shell 12.

The flexible tie 24 may be in the form of a length of wire rope which is of relatively smaller cross-sectional dimension than existing liner bolts 14.

The retainer fitting 26 may be dimensioned so as to prevent the retainer fitting 26 From passing through the liner aperture 28. More specifically, the retainer fitting 26 may be generally tapered in a profile which is the negative of a profile of the socket 34 such that the retainer fitting 26 seats within the socket 34 to form a firm anchorage to prevent further outward movement of the liner fastener 22 relative to the liner 10.

The retainer fitting 26 may be dimensioned so as to prevent lateral movement of the liner 10 relative to the shell 12. More specifically, the retainer fitting 26 may generally be dimensioned so as to extend into the mounting aperture 32 in the shell 12 once the retainer fitting 26 is seated in the socket 34 such that any shearing forces between the liner 10 and shell 12 are exerted on the retainer fitting 26 and not the flexible tie 24.

The tensioning fitting 30 may be in the form of a wedge collar 38 and barrel 40 assembly. The wedge collar 38 is arranged within a tapered interior of the barrel 40 to permit one-way movement of the assembly along the flexible tie 24. The inside surface of the wedge collar 38 may be formed with teeth to allow the wedge collar 38 to be slid onto the flexible tie 24 but to prevent withdrawal of the wedge collar 38 from the flexible tie 24 so that tension in the flexible tie 24 is maintained. The wedge collar 38 and barrel 40 assembly may be used in combination with a washer 42, that may comprise a recessed O-ring 44 for sealing between the mill shell 12 and washer 42 to prevent leakage of the mill contents through the mounting aperture 32 of the shell 12. It will be appreciated by those skilled in the art that, in other examples, alternative forms of tensioning fitting 30 may be used.

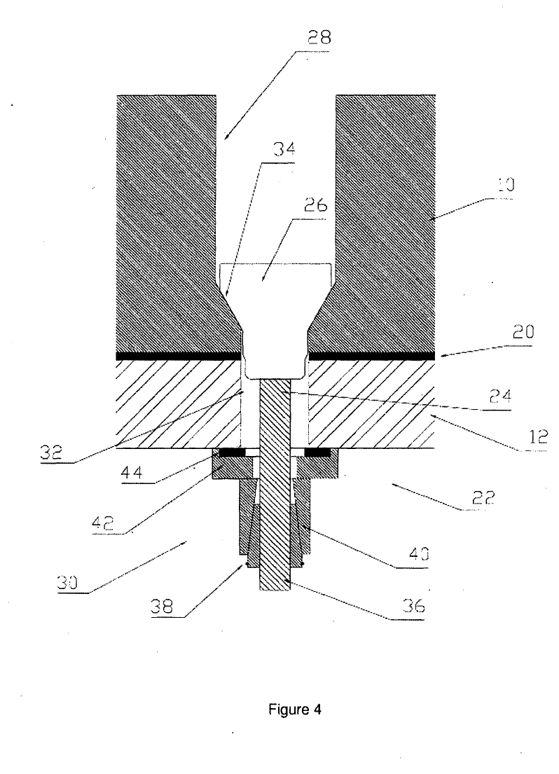

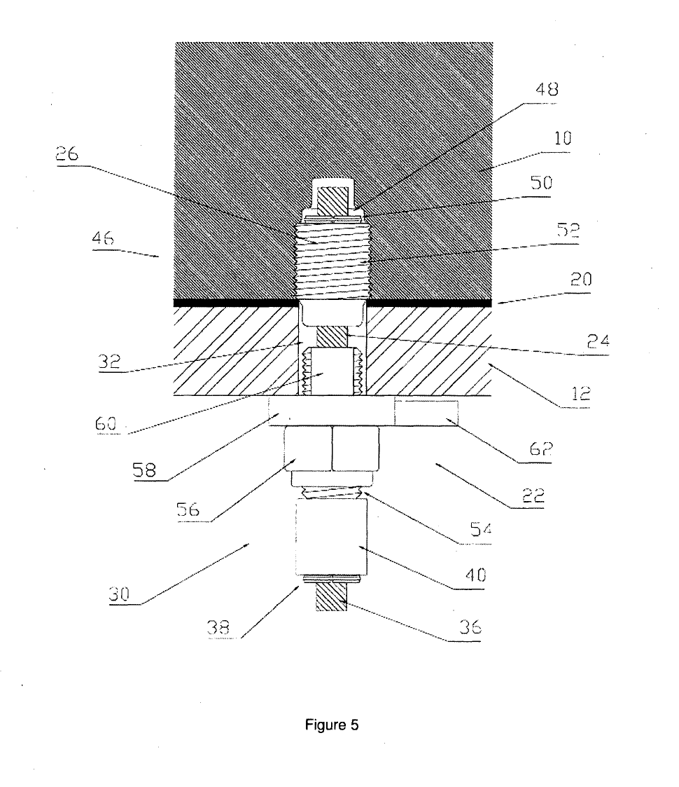

In use, the flexible tie 24 may be inserted into the liner aperture 28 and a corresponding mounting aperture 32 in the shell 12, and be fed through such that the retainer fitting 26 becomes anchored within the socket 34 formed in the aperture 28 of the liner 10. As shown in FIGS. 3 and 4, the wedge collar 38 and barrel 40 assembly may be fitted to the end portion 36 of the flexible tie 24 protruding outside the shell 12 to bear against the shell 12 and to maintain tension in the fastener 22 to thereby fasten the liner 10 to the shell 12. A hydraulic tensioning tool (such as a mono-strand stressing jack) may be used to produce the required tension in the flexible tie 24, or an alternative means of, or device for, producing and maintaining tension in the flexible tie 24 may be used, such as one that takes advantage of a screw thread. When removal of the liner 10 is required, a nut splitter or cutter, or an oxy-fuel cutting torch, may be used to remove the wedge collar 38 and barrel 40 assembly. Alternative methods may be used to remove the wedge collar 38 and barrel 40 assembly, or an alternative tensioning fitting 30. The liner 10, including the liner fasteners 22, can then be removed as per the typical practice. This may be done without first removing the liner fasteners 22 because, unlike conventional liner bolts 14, the tie 24 will flex while the liner 10 is removed, thereby assisting in preventing jamming.

Turning to FIG. 5, the retainer fitting 26 may be in the form of a wedge collar and barrel assembly. This is in contrast to the arrangements shown in FIGS. 2 to 4 wherein the retainer fitting 26 is fixedly coupled to the flexible tie, for example by way of a swaging process. More specifically, in the example shown in FIG. 5, the retainer fitting 26 may comprise a barrel 52 having a tapered internal bore, within which a wedge collar 50 is arranged to grip and anchor the flexible tie 24 to the retainer fitting 26. It will he appreciated by those skilled in the art that, in other examples, alternative means of anchoring the flexible tie 24 to the retainer fitting 26 may be used.

Accordingly, FIG. 5 shows an alternative liner fastener 22 for fastening a liner 10 to a rotatable shell 12 of a grinding mill. The fastener 22 comprises the flexible tie 24, retaining means 46 (including the retainer fitting 26, and mating threads between the barrel 52 and the liner recess 48) for retaining the fastener 22 relative to the liner 10, and a tensioning fitting 30. The flexible tie 24 is adapted to be inserted through the mounting aperture 32 in the shell 12. The tensioning fitting 30 is adapted to be fitted to an end portion 36 of the flexible tie 24 protruding outside the shell 12 to bear against the shell 12 and to maintain tension in the fastener 22 to thereby fasten the liner 10 to the shell 12.

The retainer fitting 26 in the form of the wedge collar 50 and barrel 52 assembly may be integrated within the liner 10. In use the flexible tie 24 may be inserted from an outside of the rotatable shell 12, through the mounting aperture 32 in the shell 12, and into the wedge collar 50 and barrel 52 assembly, such that the wedge collar 50 and barrel 52 assembly becomes attached to an inner end portion of the flexible tie 24. Advantageously, this removes the requirement for an aperture 28 through the liner 10 which would typically lead to accelerated wear rates in that area of the liner 10. This may prolong the useful life of the liner 10. Advantageously, fewer personnel may be required inside the mill during the liner replacement process as the fastener 22 may be fitted from outside the mill.

The tensioning fitting 30 may also comprise a wedge collar 38 and barrel 40 assembly, and a threaded stud 54, nut 56, and washer 58 assembly. The stud 54 is adapted to have an internal bore through which the flexible tie 24 can pass, and is adapted to have a non-round cross-sectional dimension 60 (for example with planar opposed surfaces) along a portion of its length. The washer 58 is adapted to have a corresponding non-round bore within which the stud 54 is arranged, and which is configured to prevent rotation of the stud 54 relative to the washer 58, and an arm 62 extending beyond an outer diameter of the washer 58. In use, torque may be applied to the nut 56, whilst rotation of the stud 54 and washer 58 is prevented via a reactionary force applied to the arm 62, thereby ensuring the applied torque is converted into a linear force, and subsequently tension in the fastener 22.

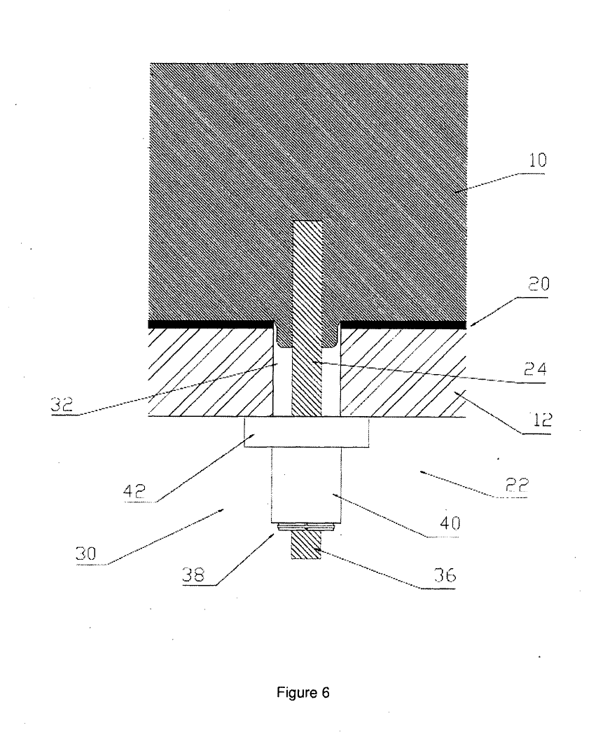

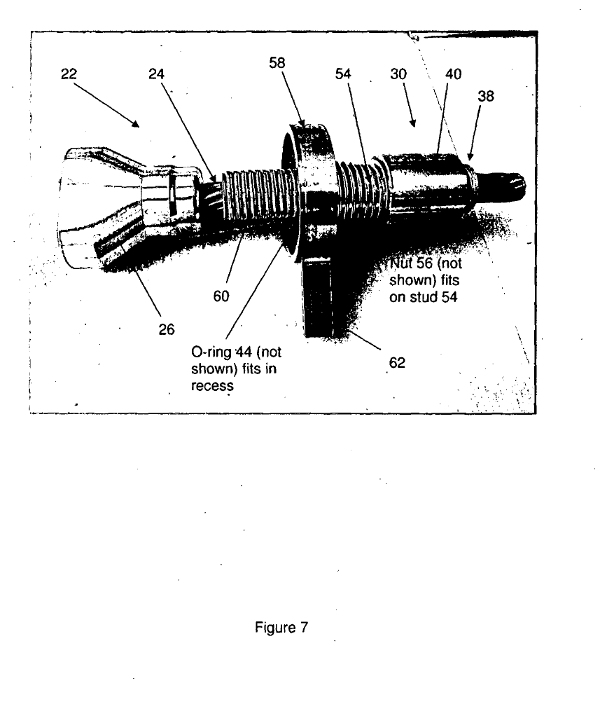

With reference to FIG. 6, there is shown an alternative example in which the fastener 22 is retained relative to the liner 10 by way of one end portion of the flexible tie 24 being embedded in the liner 10. In a similar manner to the example depicted in FIG. 5, this embodiment also removes the requirement for an aperture 28 through the liner 10 which would typically lead to accelerated wear rates in that area of the liner 10.

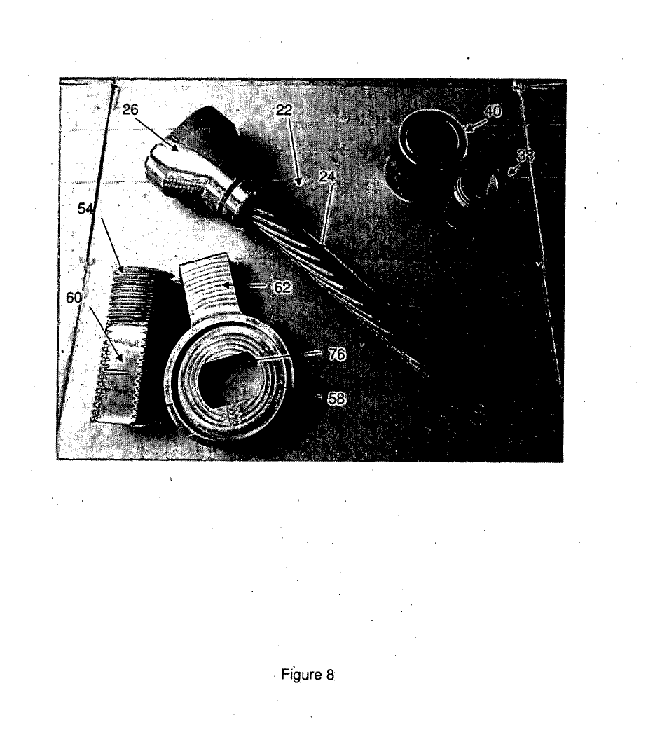

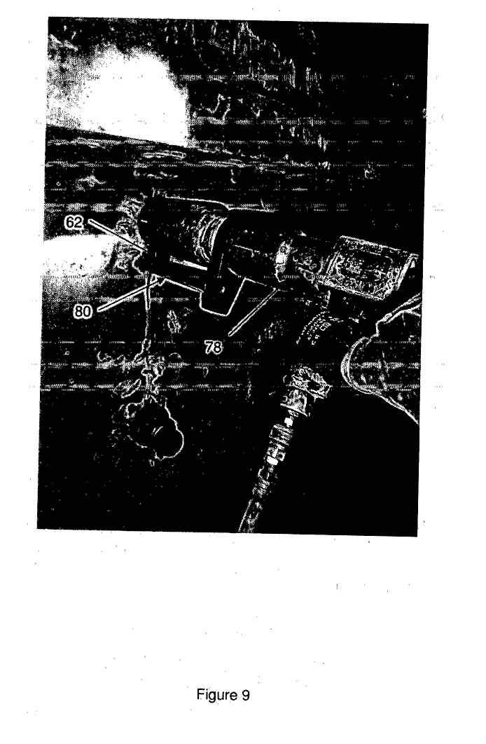

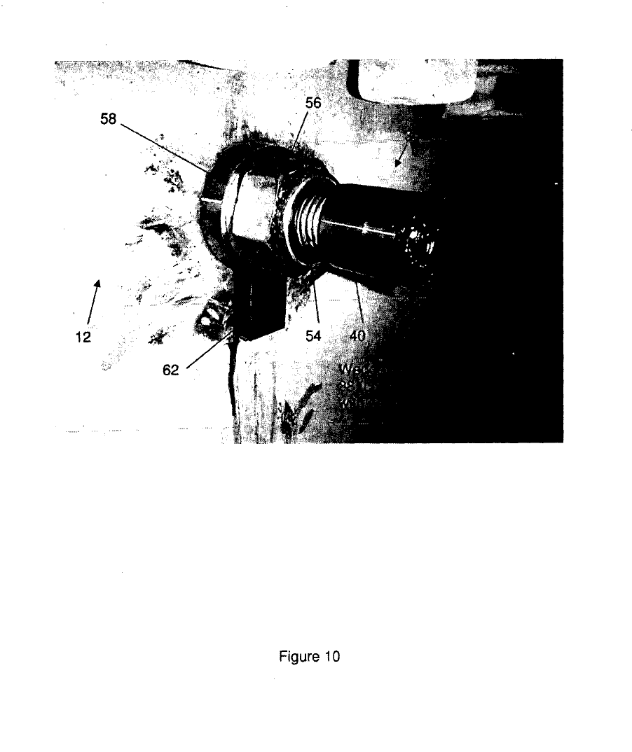

FIGS. 7 to 10 show a trial liner fastener 22 in accordance with an actual physical embodiment of the present invention. More, specifically, FIG. 7 shows the trial fastener 22 in an assembled condition. FIG. 8 shows components of the trial fastener 22 in a disassembled condition. FIG. 9 shows the trial fastener 22 being tensioned by way of a torque gun 78, and FIG. 10 shows the trial fastener 22 once installed from outside the mill shell 12. As can be seen, the trial fastener 22 includes a retainer fitting 26 having a tapered profile, and a tensioning fitting 30 including a wedge collar 38 and barrel 40 assembly. The retainer fitting 26 is in the form of a wedge collar and barrel assembly. the wedge collar being arranged deeply (out of view) within the tapered interior of the barrel. Also shown is a stud 54 and a washer 58 which fits over the stud 54 and rotationally engages the stud 54. The washer 58 has a recess for housing a standard rubber O-ring 44. FIG. 8 shows the various components of the trial fastener 22 in a disassembled condition, depicting the wedge 38 removed from the barrel 40, and the washer 58 removed from the stud 54. Also depicted is the stud 54 having opposed planar side surfaces 60 for engagement within a correspondingly shaped bore 76 formed in the washer 58.

FIG. 9 shows the trial fastener 22 being tensioned using the torque gun 78, a reaction arm 80 of which rests against the arm 62 of the washer 58. With reference to FIG. 10, the trial fastener 22 is shown in a fastened condition in which the washer 58 rests against the shell 12, and the nut 56 rests against the washer 58. In being tensioned, the nut 56 drives the stud 54 outwardly through the nut 56 against the tensioning fitting 30 so as to increase tension in the flexible tie 24.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A liner fastener for fastening a liner to a rotatable shell of a grinding mill, the fastener comprising a flexible tie, a retainer fitting for retaining the fastener relative to an aperture of the liner, and a tensioning fitting, wherein the flexible tie is adapted to be inserted into the liner aperture and a corresponding mounting aperture in the shell and fed through such that the retainer fitting becomes anchored within a socket formed in the aperture of the liner, and the tensioning fitting is adapted to be fitted to an end portion of the flexible tie protruding outside the shell to bear against the shell and to maintain tension in the fastener to thereby fasten the liner to the shell.

2. (canceled)

3. (canceled)

4. A liner fastener as claimed in claim 1, wherein the flexible tie is in the form of a length of wire rope.

5. A liner fastener as claimed in claim 1, wherein the retainer fitting is in the form of a wedge collar and barrel assembly.

6. A liner fastener as claimed in claim 1 wherein the flexible tie is anchored to the retainer fitting by way of a swaging process.

7. A liner fastener as claimed in claim 1, wherein the retainer fitting is dimensioned so as to prevent the retainer fitting from passing through the liner aperture.

8. A liner fastener as claimed in claim 1, wherein the retainer fitting is dimensioned so as to prevent lateral movement of the liner relative to the shell.

9. A liner fastener as claimed in claim 1 wherein the tensioning fitting is in the form of a wedge collar and barrel assembly, the wedge collar being arranged within a tapered interior of the barrel to permit one-way movement of said assembly along the flexible tie.

10. A liner fastener as claimed in claim 1 when used to fasten a liner to a rotatable shell of a grinding mill, the fastener comprising a flexible tie, a retainer fitting, and a tensioning fitting, wherein the flexible tie is inserted into a liner aperture and a corresponding mounting aperture in the shell, the retainer fitting is anchored within a socket formed in the liner aperture to anchor the fastener against displacement through the liner aperture, and the tensioning fitting is fitted to an end portion of the flexible tie protruding outside the shell, the tensioning fitting bearing against the shell to maintain tension in the flexible tie thereby fastening the liner to the shell.

11. A liner fastener as claimed in claim 10, wherein the flexible tie is inserted from an inside of the liner.

12. A method of fastening a liner to a rotatable shell of a grinding mill, the fastener comprising a flexible tie, a retainer fitting for retaining the fastener relative to an aperture of the liner, and a tensioning fitting, the method including the steps of:
inserting the flexible tie into the liner aperture and a corresponding mounting aperture in the shell;
feeding the flexible tie through the liner aperture such that the retainer fitting becomes anchored within a socket formed in the aperture of the liner; and
fitting the tensioning fitting to an end portion of the flexible tie protruding outside the shell with the tensioning fitting bearing against the shell to maintain tension in the fastener to thereby fasten the liner to the shell.

13. A liner fastener for fastening a liner to a rotatable shell of a grinding mill, the fastener comprising a flexible tie, retaining means for retaining the fastener relative to the liner, and a tensioning fitting, wherein the flexible tie is adapted to be inserted through a mounting aperture in the shell, and the tensioning fitting is adapted to be fitted to an end portion of the flexible tie protruding outside the shell to bear against the shell and to maintain tension in the fastener to thereby fasten the liner to the shell.

14. A liner fastener as claimed in claim 13, wherein the retaining means is in the form of one end portion of the flexible tie being embedded in the liner.

15. A liner fastener as claimed in claim 13, wherein the retaining means is in the form of one end portion of the flexible tie being integrally formed as part of the liner.

16. A liner fastener as claimed in claim 13, wherein the retaining means is in the form of a retainer fitting attached to one end portion of the flexible tie.

17. A liner fastener as claimed in claim 13, wherein the retaining means is in the form of a retainer fitting integrated within the liner, adapted such that the flexible tie may be inserted from an outside of the rotatable shell, through a mounting aperture in the shell, and into the retainer fitting, such that the retainer fitting becomes attached to one end portion of the flexible tie.

18. A liner fastener as claimed in claim 16, wherein the retainer fitting is in the form of a wedge collar and barrel assembly.

19. A liner fastener as claimed in claim 13, wherein the retaining means is dimensioned so as to prevent lateral movement of the liner relative to the mill shell.

20. A liner fastener defined in claim 13 when used to fasten a liner to a rotatable shell of a grinding mill, the fastener comprising a flexible tie, retaining means for retaining the fastener relative to the liner, and a tensioning fitting, wherein the flexible tie is inserted through a mounting aperture in the shell, and the tensioning fitting is fitted to an end portion of the flexible tie protruding outside the shell, the tensioning fitting bearing against the shell to maintain tension in the flexible tie thereby fastening the liner to the shell.

21. A method of fastening a liner to a rotatable shell of a grinding mill, the fastener comprising a flexible tie, retaining means for retaining the fastener relative to the liner, and a tensioning fitting, the method including the steps of:
inserting the flexible tie through a mounting aperture in the shell; and
fitting the tensioning fitting to an end portion of the flexible tie protruding outside the shell with the tensioning fitting bearing against the shell to maintain tension in the fastener to thereby fasten the liner to the shell.

22. (canceled)

23. (canceled)

24. (canceled)

25. A liner fastener as claimed in claim 10, wherein the flexible tie is inserted from an outside of the liner.
